(19) United States
(12) Patent Application Publication
(10) Pub. No.: US 2012/0110578 A1
(43) Pub. Date: May 3, 2012

(54) DATA PROCESSING SYSTEM AND METHOD

(76) Inventor: Yu YANG, Chengdu (CN)

(21) Appl. No.: 13/348,955

(22) Filed: Jan. 12, 2012

Related U.S. Application Data
(63) Continuation of application No. PCT/CN2010/075339, filed on Jul. 21, 2010.

(30) Foreign Application Priority Data
Jul. 22, 2009 (CN) 200910089754.8

(51) Int. Cl. G06F 9/455

(52) U.S. Cl. 718/1

(57) ABSTRACT

A data processing system includes a hardware platform, a virtualization platform, a physical machine, and at least two virtual machines. The virtual machines run on the virtualization platform. The physical machine is configured to bear the virtualization platform. The physical machine is connected to the hardware platform through a system bus. The hardware platform is configured to process data sent by a first virtual machine and send the processed data to a second virtual machine. The hardware platform is employed to process data transmission or data exchange between various virtual machines, so that the virtual machines occupy fewer Central Processing Unit (CPU) and memory resources of the physical machine that bears the running of the virtual machines, the system resource consumption is reduced, and the running performance and speed of the system are improved.

### CROSS-REFERENCE TO RELATED APPLICATION

This application is a continuation of International Application PCT/CN2010/075339, filed on Jul. 21, 2010, which claims priority to Chinese Patent Application No. 200910089754.8, filed on Jul. 22, 2009, both of which are hereby incorporated by reference in their entireties.

### FIELD OF THE INVENTION

The present invention relates to the field of computer technologies, and in particular, to a data processing system and method.

### BACKGROUND OF THE INVENTION

The origin of virtualization can be traced back to the era of mainframe computers. Due to high cost and strong processing capabilities of the mainframe computers, some manufacturers begin to develop a virtualization system, so as to enable different users to run different operating systems and application environments on the same mainframe computer, which is a rudiment of the current virtualization technology. With increasingly enhanced processing capabilities of computers based on an X86 architecture, the demand for virtualization increases. At first, the virtualization merely aims to integrate resources and improve resource utilization. However, with the rapid development and a deeper understanding of the virtualization technology, the virtualization technology is in great demand in terms of disaster recovery, storage, and even business operation.

In the current virtualization technology, the hardware architecture supports virtualization merely on the Central Processing Unit (CPU) level for the following reason. Currently provided virtualization functions, including data transmission and data exchange between different virtual machines, are almost always implemented by software. Therefore, compared with data transmission or exchange between physical machines, during file transmission or exchange between different virtual machines, both the resource consumption of a CPU and the total resource consumption of the CPU and a memory of a physical machine that bears the running of the virtual machines are high, and a lot of system resources are occupied. As a result, a server consumes tremendous resources in data transmission and data exchange, supported data traffic is not so large, and the performance and speed of the entire system are decreased dramatically.

### SUMMARY OF THE INVENTION

Embodiments of the present invention provide a data processing system and method, for occupying less the CPU and memory of a physical machine that bears the running of virtual machines during data processing between the virtual machines, reducing system resource consumption, and improving the running performance and speed of the system.

An embodiment of the present invention provides a data processing system, where the data processing system includes: a hardware platform, a virtualization platform, a physical machine, and at least two virtual machines. The virtual machines run on the virtualization platform. The physical machine is configured to bear the virtualization platform. The physical machine is connected to the hardware platform through a system bus. The hardware platform is configured to process data send by a first virtual machine and sent the processed data to a second virtual machine.

An embodiment of the present invention provides a data processing method, where the data processing method includes:

receiving, by a hardware platform, through a system bus, data sent by a first virtual machine; and

processing, by the hardware platform, the data sent by the first virtual machine and then sending the processed data to a second virtual machine, in which

the first virtual machine and the second virtual machine run on the same virtualization platform.

In the data processing system and method according to the embodiments of the present invention, data transmission or data exchange between various virtual machines is processed by the hardware platform, so that the virtual machines occupy less the CPU and memory of the physical machine that bears the running of the virtual machines, the system resource consumption is reduced, and the running performance and speed of the system are improved.

### BRIEF DESCRIPTION OF THE DRAWINGS

To illustrate the technical solutions according to the embodiments of the present invention, the accompanying drawings for describing the embodiments are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic structure diagram of a data processing system according to Embodiment 1 of the present invention;

FIG. 2 is another schematic structure diagram of the data processing system according to Embodiment 1 of the present invention;

FIG. 3 is a schematic structure diagram of the data processing system according to Embodiment 1 of the present invention in which a physical machine is connected to a hardware platform;

FIG. 4 is a schematic structure diagram of a data processing system according to Embodiment 2 of the present invention; and

FIG. 5 is a flow chart of a data processing method according to Embodiment 3 of the present invention.

### DETAILED DESCRIPTION OF THE EMBODIMENTS

The technical solutions according to the embodiments of the present invention will be clearly and completely described in the following with reference to the accompanying drawings. It is obvious that the embodiments to be described are only a part rather than all of the embodiments of the present invention. All other embodiments obtained by persons of ordinary skill in the art based on the embodiments of the present invention without creative efforts shall fall within the protection scope of the present invention.

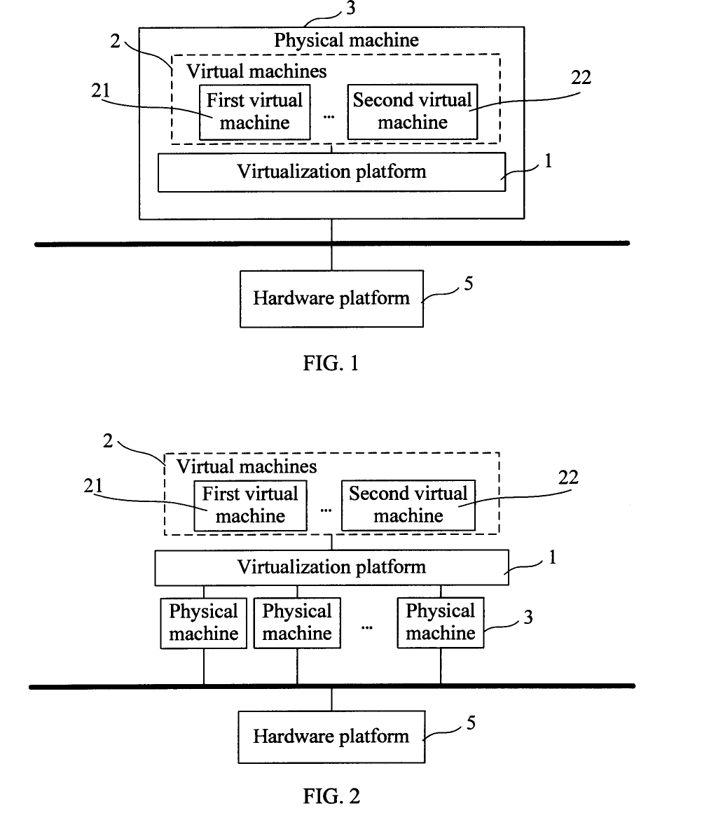

FIG. 1 is a schematic structure diagram of a data processing system according to Embodiment 1 of the present invention. FIG. 1 shows the situation that one physical machine bears one virtualization platform. The data processing system includes a hardware platform 5, a virtualization platform 1, a physical machine 3, and at least two virtual machines 2. The virtual machines 2 include a first virtual machine 21 and a second virtual machine 22. The physical machine 3 is connected to the hardware platform 5 through a system bus. The physical machine 3 is configured to bear the virtualization platform 1. The virtual machines 2 run on the virtualization platform 1. The hardware platform 5 is configured to process data send by the first virtual machine 21 and sent the processed data to the second virtual machine 22.

The virtual machine 2 is a complete computer system simulated by software, having complete functions of a hardware system, and running in an entirely isolated environment. The virtualization platform 1 refers to a computer software platform formed of multiple virtual machines by software simulation that has complete functions of a hardware system and supports interactive running of multiple virtual machines.

Further, in the data processing system according to the embodiment of the present invention, in addition to the situation that one virtualization platform is borne by one physical machine in FIG. 1, one virtualization platform may also be borne by multiple physical machines. FIG. 2 is another schematic structure diagram of the data processing system according to Embodiment 1 of the present invention. FIG. 2 shows the situation that multiple physical machines 3 bear one virtualization platform 1, that is, the virtual machines 2 may also run on a single virtualization platform 1 based on the multiple physical machines 3. The physical machines 3 are connected to the hardware platform 5 through the system bus. The hardware platform 5 may process data sent by the first virtual machine 21 and send the processed data to the second virtual machine 22.

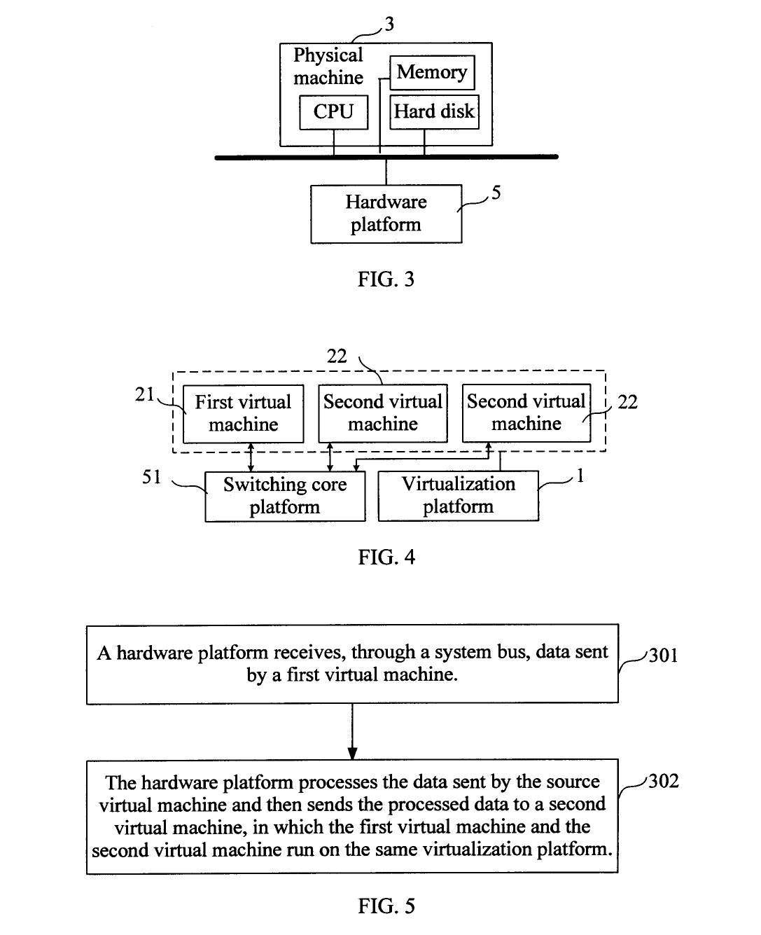

FIG. 3 is a schematic structure diagram of the data processing system according to Embodiment 1 of the present invention in which the physical machine is connected to the hardware platform. As shown in FIG. 3, each physical machine 3 is formed by a CPU, a memory, a hard disk, and other hardware. The CPU, memory, and hard disk of the physical machine are connected to the system bus. The system bus is further connected to the hardware platform 5. The connection between the hardware platform 5 and the system bus may adopt various bus technologies, for example, Peripheral Component Interconnect (PCI), PCI-Express (PCIE), Advanced Technology Attachment (ATA), Serial Advanced Technology Attachment (SATA), Serial Attached Small Computer System Interface (SCSI), Infiniband, or Localbus.

Specifically, during application, data in the virtualization platform that originally occupies CPU and memory resources of the physical machine for processing (for example, data exchange between the first virtual machine and the second virtual machine is implemented by software) may be set to be processed by the hardware platform, and data from the first virtual machine is processed and then the processed data is sent to the second virtual machine by the hardware platform. The hardware platform may include, but not limited to, a hardware platform centered on data exchange, a hardware platform centered on a firewall, a hardware platform centered on virus prevention, a hardware platform centered on content filtering, and a hardware platform centered on data encryption and/or decryption.

Specifically, if the hardware platform is designed as a module centered on exchange, the hardware platform may be employed to process Layer 2 switching and Layer 3 switching of data between the first virtual machine and the second virtual machine. If the hardware platform is designed as a module centered on a firewall, the hardware platform may be employed to implement the functions of the firewall for the virtual machines. If the hardware platform is designed as a module centered on virus prevention, the hardware platform may be employed to implement virus prevention of a network of the virtual machines. If the hardware platform is designed as a module centered on content filtering, the hardware platform may be employed to filter content of data packets from the first virtual machine, so as to improve the information security of data flows between the first virtual machine and the second virtual machine. If the hardware platform is designed as a module centered on data encryption and/or decryption, virtual channels, secure channels, or virtual secure channel may be established between the virtual machines through encapsulation, encryption and/or decryption, and reliability verification of network data, thereby achieving the purpose of network application extension and data security through hardware.

In addition, in the specific application, hardware modules implementing multiple functions may also be integrated into one hardware platform, so as to correspondingly process data transmitted between the virtual machines by means of the hardware platform.

In this embodiment, the hardware platform is employed to process data transmission or data exchange between various virtual machines, so that the virtual machines occupy fewer CPU and memory resources of the physical machine, the system burden is alleviated, and the running efficiency of the virtual machines is improved. In addition, the physical machine is enabled to support large data traffic, so that the functions of the virtual machines borne by the physical machine can be extended without being limited by the CPU and memory resources, and the performance of the virtual machines is improved.

FIG. 4 is a schematic structure diagram of a data processing system according to Embodiment 2 of the present invention. As shown in FIG. 4, based on the first embodiment of the virtualization platform according to the present invention, taking the hardware platform being a hardware platform centered on data exchange as an example, the data processing system includes a virtualization platform 1, a first virtual machine 21, a second virtual machine 22, and a switching core platform 51. The virtualization platform 1 is configured to form multiple virtual machines into a computer virtualization platform that has complete functions of a hardware system and supports interactive running of multiple virtual machines by software simulation. The first virtual machine 21 and the second virtual machine 22 are both complete computer systems simulated by software, having complete functions of a hardware system, and running in an entirely isolated environment. The switching core platform 51 is configured to perform Layer 2 switching and Layer 3 switching on data transmitted between the first virtual machine 21 and the second virtual machine. Specifically, Media Access Control (MAC), address management, and data packet addressing involved in the data exchange process are all processed by the switching core platform 51, so as to increase the processing speed of data exchange between the virtual machines.

In one embodiment, when the hardware platform is a hardware platform centered on a firewall, functions of the firewall such as Network Address Translation (NAT) and access control may be implemented by the hardware platform.

In another embodiment, when the hardware platform is a hardware platform centered on virus prevention, processing such as keyword detection, malicious code detection, and behavior monitoring may be performed on data packets transmitted between the virtual machines by the hardware platform, so as to implement highly efficient virus filtering and illegal behavior monitoring between the virtual machines.

In a further embodiment, when the hardware platform is a hardware platform centered on content filtering, processing such as content monitoring, cross-packet filtering, and label search may be performed on data packets by the hardware platform, so as to implement content filtering on data flows between the virtual machines within the virtualization platform.

In a further embodiment, when the hardware platform is a hardware platform centered on data encryption and/or decryption, processing such as encryption and/or decryption may be performed on data of the first virtual machine and the second virtual machine within the virtualization platform by the hardware platform.

In addition, the aforementioned various platforms may also be integrated into one hardware platform and connected to a system bus, so as to process data of each virtual machine by means of hardware in the hardware platform.

In this embodiment, various hardware platforms are employed to implement functions such as network, data, and system security as well as data transmission and buffering between various virtual machines within the virtualization platform, so as to occupy fewer CPU and memory resources of the physical machine that bears the running of the virtual machines, alleviate system burden, and improve the running performance and efficiency of the virtual machines.

FIG. 5 is a flow chart of a data processing method according to Embodiment 3 of the present invention. As shown in FIG. 5, the data processing method of a virtualization platform includes the following steps.

Step 301: A hardware platform receives, through a system bus, data sent by a first virtual machine.

It should be understood that, the virtual machine may be a complete computer system simulated by software, having complete functions of a hardware system, and running in an entirely isolated environment.

Step 302: The hardware platform processes the data sent by the first virtual machine and then sends the processed data to a second virtual machine, in which the first virtual machine and the second virtual machine run on the same virtualization platform.

The virtualization platform refers to a computer software platform formed of multiple virtual machines by software simulation that has complete functions of a hardware system and supports interactive running of multiple virtual machines.

The method for the hardware platform to process the data sent by the first virtual machine and then send the processed data to the second virtual machine may include the following step.

The hardware platform forwards the data sent by the first virtual machine to the second virtual machine.

The hardware platform may encrypt or decrypt the data sent by the first virtual machine and then send the encrypted or decrypted data to the second virtual machine.

The hardware platform may perform security detection on the data sent by the first virtual machine, and send data passing the security detection to the second virtual machine.

Specifically, when the hardware platform is a hardware platform centered on data exchange, network card MAC, address management, data packet addressing, and Quality of Service (QoS) processing are performed on data flows between the first virtual machine and the second virtual machine by hardware within the hardware platform, so as to implement Layer 2 switching and Layer 3 switching on data between the first virtual machine and the second virtual machine.

When the hardware platform is a hardware platform centered on a firewall, processing such as security detection, authority control, NAT, access control, and data packet filtering are performed on data packets from the first virtual machine and the processed data is sent to the second virtual machine by hardware in the hardware platform, so as to improve the security of data transmission between the first virtual machine and the second virtual machine.

When the hardware platform is a hardware platform centered on virus prevention, processing such as core keyword detection, malicious code detection, and behavior monitoring may be performed on data packets from the first virtual machines and then the processed data packets may be sent to the second virtual machine by hardware in the hardware platform, so as to implement virus detection on data between the first virtual machine and the second virtual machine, thereby improving the security of data transmission.

When the hardware platform is a hardware platform centered on content filtering, processing such as content detection, cross-packet filtering, and label search may be performed on data packets from the first virtual machine and then the processed data may be sent to the second virtual machine by the hardware platform, so as to implement security detection on data between the first virtual machine and the second virtual machine, thereby improving the security of data transmission.

When the hardware platform is a hardware platform centered on data encryption and/or decryption, data packets from the source virtual may be encrypted and/or decrypted and the encrypted and/or decrypted data may be sent to the second virtual machine by the hardware platform, so as to establish a secure channel between the first virtual machine and the second virtual machine.

In this embodiment, the hardware platform is employed to process data transmission or data exchange between the virtual machines within the virtualization platform, so as to occupy fewer CPU and memory resources of the physical machine that bears the running of the virtual machines during the running of the virtual machines, thereby improving the running performance and efficiency of the virtual machines.

Persons of ordinary skill in the art should understand that all or a part of the steps of the method according to the embodiment may be implemented by a program instructing relevant hardware. The program may be stored in a computer readable storage medium. When the program is run, the steps of the method according to the embodiment are performed. The storage medium includes any medium that is capable of storing program codes, such as a Read-Only Memory (ROM), a Random Access Memory (RAM), a magnetic disk, and an optical disk.

It should be noted that the above embodiments are merely provided for describing the technical solutions of the present invention, but not intended to limit the present invention. It should be understood by persons of ordinary skill in the art that although the present invention has been described in detail with reference to the embodiments, modifications can be made to the technical solutions described in the embodiments, or equivalent replacements can be made to some technical features in the technical solutions, as long as such modifications or replacements do not cause the essence of corresponding technical solutions to depart from the spirit and scope of the present invention.

What is claimed is:

1. A data processing system, comprising a hardware platform, a virtualization platform, a physical machine, and at least two virtual machines including a first virtual machine and a second virtual machine, wherein the virtual machines run on the virtualization platform, the physical machine is configured to bear the virtualization platform, the physical machine is connected to the hardware platform through a system bus, and the hardware platform is configured to process data sent by the first virtual machine and send the processed data to the second virtual machine.

2. The data processing system according to claim 1, wherein the data processing system includes multiple physical machines that bear the virtualization platform.

3. The data processing system according to claim 1, wherein the hardware platform comprises a hardware platform centered on data exchange, a hardware platform centered on a firewall, a hardware platform centered on virus prevention, a hardware platform centered on content filtering, and a hardware platform centered on data encryption and/or decryption.

4. A data processing method, comprising:
receiving, by a hardware platform, through a system bus, data sent by a first virtual machine; and
processing, by the hardware platform, the data sent by the first virtual machine and sending the processed data to a second virtual machine, wherein the first virtual machine and the second virtual machine run on the same virtualization platform.

5. The data processing method according to claim 4, wherein the processing, by the hardware platform, the data sent by the first virtual machine and the sending the processed data to the second virtual machine comprise: forwarding, by the hardware platform, the data sent by the first virtual machine to the second virtual machine.

6. The data processing method according to claim 4, wherein the processing, by the hardware platform, the data sent by the first virtual machine and the sending the processed data to the second virtual machine comprise: encrypting or decrypting, by the hardware platform, the data sent by the first virtual machine and sending the encrypted or decrypted data to the second virtual machine.

7. The data processing method according to claim 4, wherein the processing, by the hardware platform, the data sent by the first virtual machine and the sending the processed data to the second virtual machine comprise: performing, by the hardware platform, security detection on the data sent by the first virtual machine, and sending data passing the security detection to the second virtual machine.

8. The data processing system according to claim 2, wherein the hardware platform comprises a hardware platform centered on data exchange, a hardware platform centered on a firewall, a hardware platform centered on virus prevention, a hardware platform centered on content filtering, and a hardware platform centered on data encryption and/or decryption.

9. A computer readable storage medium storing a program of instructions executable by a machine to perform a method of processing data, the method comprising:
receiving, by a hardware platform, through a system bus, data sent by a first virtual machine; and
processing, by the hardware platform, the data sent by the first virtual machine and sending the processed data to a second virtual machine, wherein the first virtual machine and the second virtual machine run on the same virtualization platform.

10. The computer readable storage medium of claim 9, wherein the processing, by the hardware platform, the data sent by the first virtual machine and the sending the processed data to the second virtual machine comprise: forwarding, by the hardware platform, the data sent by the first virtual machine to the second virtual machine.

11. The computer readable storage medium of claim 9, wherein the processing, by the hardware platform, the data sent by the first virtual machine and the sending the processed data to the second virtual machine comprise: encrypting or decrypting, by the hardware platform, the data sent by the first virtual machine and sending the encrypted or decrypted data to the second virtual machine.

12. The computer readable storage medium of claim 9, wherein the processing, by the hardware platform, the data sent by the first virtual machine and the sending the processed data to the second virtual machine comprise: performing, by the hardware platform, security detection on the data sent by the first virtual machine, and sending data passing the security detection to the second virtual machine.
